(19) United States
(12) Patent Application Publication
(10) Pub. No.: US 2022/0355385 A1
(43) Pub. Date: Nov. 10, 2022

(54) METHODS AND SYSTEMS FOR ADDITIVELY MANUFACTURING DENSIFIED COMPONENTS

(71) Applicant: Baker Hughes Oilfield Operations LLC, Houston, TX (US)

(72) Inventors: Wei Chen, Sugar Land, TX (US); Navin Sakthivel, Spring, TX (US); Aaron Avagliano, Tomball, TX (US)

(21) Appl. No.: 17/313,832

(22) Filed: May 6, 2021

(51) Int. Cl. B22F 12/60; B22F 10/10; B33Y 10/00; B33Y 30/00

(52) U.S. Cl. CPC B22F 12/60; B22F 10/10; B33Y 10/00; B33Y 30/00

(57) ABSTRACT

A method of additive manufacturing may include disposing a layer of a powder material on a surface of a build platform of an additive manufacturing apparatus. The method may also include placing a compaction platform comprising one or more transducers in contact with an upper surface of the layer of the powder material. The method may additionally include activating at least one transducer of one or more transducers of the compaction platform of the compactor to densify a portion of the layer of the powder material below the at least one transducer while at least the weight of the compaction platform applies a normal force to the layer of the powder material. Related systems for densifying additively manufactured components are also described.

### TECHNICAL FIELD

This disclosure relates generally to additive manufacturing. This disclosure further relates to methods and systems for additively manufacturing densified components.

### BACKGROUND

Three-dimensional additive manufacturing, also termed “printing,” involves the spreading of a layer of particulate material and then binding selected portions of the particulate layer together, for example by laser sintering, activating adhesive material coating the particles, or jetting an adhesive binder fluid onto the particulate layer. This sequence is repeated for additional particulate layers until a desired structure has been constructed. The material making up the particulate layer is often referred to as the “build material” or “the build material powder” and a coating or jetted fluid is often referred to as a “binder,” or in some cases, an “activator.” Post-processing of the three-dimensionally printed part is often required in order to strengthen and/or densify the part.

Various methods are used to supply each new powder layer for three-dimensional printing. For example, some three-dimensional printers have a powder supply platform that contains powder supported upon a vertically indexable platform and use a counter-rotating roller or a recoater to transfer a predetermined amount of powder from the top of the powder supply platform to the top of a build platform. Some other three-dimensional printers utilize a traveling dispenser nozzle to dispense each new layer of powder and a traveling blade to smooth the newly deposited layer.

Despite its advantages, conventional three-dimensional printing processes have their drawbacks. One such drawback is that the apparent “green” density of the printed structure is essentially the same as the apparent density of the powder bed that is created during the three-dimensional printing process. The apparent density of the printed structure is often in the range of about 40% to 60%, which requires a significant amount of flowable infiltrant material to be added if infiltration is to be used to densify the structure to an acceptable degree. In cases where densification is to be achieved by sintering or thermomechanical processing, the initial low apparent density of the printed structure results in a large amount of shrinkage, thus increasing the chances of the occurrence of geometrical distortion or alternatively requiring the initial structure to be formed oversize and potentially of a modified shape modeled to accommodate shrinkage and produce a final structure exhibiting acceptable dimensional tolerances.

### BRIEF SUMMARY

Embodiments of the present disclosure include additive manufacturing systems and methods. A method of additive manufacturing may include disposing a layer of a powder material on a surface of a build platform of an additive manufacturing apparatus. The method may also include placing a compaction platform comprising one or more transducers in contact with an upper surface of the layer of the powder material. The method may additionally include activating at least one transducer of one or more transducers of a compaction platform of a compactor to densify a portion of the layer of the powder material below the at least one transducer.

Additional embodiments of the present disclosure include a system for additively manufacturing components. The system for additively manufacturing components may include a build platform, a material applicator, and a compactor. The build platform may be configured to support layers of powder material forming a component. The material applicator may be configured to dispose layers of powder material over the build platform. The compactor may comprise a compaction platform movable to positions over the build platform and into contact with individual layers of the powder material after disposition thereof over the build platform. The compaction platform may additionally comprise a number of downwardly aimed ultrasonic transducers configured to densify portions of the powder material.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1 is a schematic view illustrating an additive manufacturing system in accordance with embodiments of the disclosure.

FIGS. 2A through 2H are simplified, cross-sectional views illustrating a method of additive manufacturing in accordance with embodiments of the disclosure and performed using a system as illustrated in FIG. 1.

### DETAILED DESCRIPTION

The illustrations presented herein are not actual views of any particular acoustic transducer, additive manufacturing system, or any component of such, but are merely idealized representations, which are employed to describe embodiments of the present disclosure.

As used herein, the singular forms following “a,” “an,” and “the” are intended to include the plural forms as well, unless the context clearly indicates otherwise.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, “and/or” includes any and all combinations of one or more of the associated listed items.

As used herein, “apparent density” refers to mass per unit volume of a material, including voids within and between particles of the material.

Apparent density as well as “tap density” as defined below may be, as described herein, stated as percentages of density relative to an absolute theoretical density of the material (i.e., powder) compact. Therefore, an indicated (tap or apparent) density of, for example, greater than about 60%, about 80% or more is a relative density in comparison to a 100% absolute theoretical density.

As used herein, the terms “comprising,” “including,” and grammatical equivalents thereof are inclusive or open-ended terms that do not exclude additional, un-recited elements or method steps, but also include the more restrictive terms “consisting of,” “consisting essentially of,” and grammatical equivalents thereof.

As used herein, the term “configured” refers to a size, shape, material composition, and arrangement of one or more of at least one structure and at least one apparatus facilitating operation of one or more of the structure and the apparatus in a predetermined way.

As used herein, the phrase “coupled to” refers to structures connected with each other (e.g., mechanically or electrically connected) and may refer to a direct connection or an indirect connection (e.g., by way of another structure).

As used herein, any relational term, such as “first,” “second,” etc., is used for clarity and convenience in understanding the disclosure and accompanying drawings, and does not connote or depend on any specific preference or order, except where the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, reference to a feature being “on” an additional feature includes the features being in contact with one another, as well as directly or indirectly coupled to one another, connected to one another, attached to one another, or secured to one another.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “tap density” refers to the apparent density in grams per cubic centimeter of an unconstrained powder material in a container (i.e., graduated cylinder) that has been mechanically tapped (e.g., 250 taps per minute, 300 taps per minute) under the conditions specified in ASTM B527-20, and is determined by the following equation:

$$Tap Density = \frac{Mass of powder material}{Volume of tapped powder material}$$

As used herein, the terms “vertical,” and “lateral” are in reference to a major plane of a structure and are not necessarily defined by earth's gravitational field. A “lateral” direction is a direction that is substantially parallel to the major plane of the structure, while a “vertical” direction is a direction that is substantially perpendicular to the major plane of the structure. The major plane of the structure is defined by a surface of the structure having a relatively large area compared to other surfaces of the structure. With reference to the figures, a “lateral” direction may be perpendicular to an indicated “Z” axis, and may be parallel to an indicated “X” axis and/or parallel to an indicated “Y” axis; and a “vertical” direction may be parallel to an indicated “Z” axis, may be perpendicular to an indicated “X” axis, and may be perpendicular to an indicated “Y” axis.

Some embodiments of the present disclosure include additive manufacturing systems and methods. In particular, embodiments of the present disclosure include systems and methods for selectively densifying (e.g., compacting) additively manufactured components. Embodiments of the present disclosure address problems with low apparent density of components that are formed during certain additive manufacturing processes, and may allow for engineering of microstructures of additively manufactured components to obtain certain material properties.

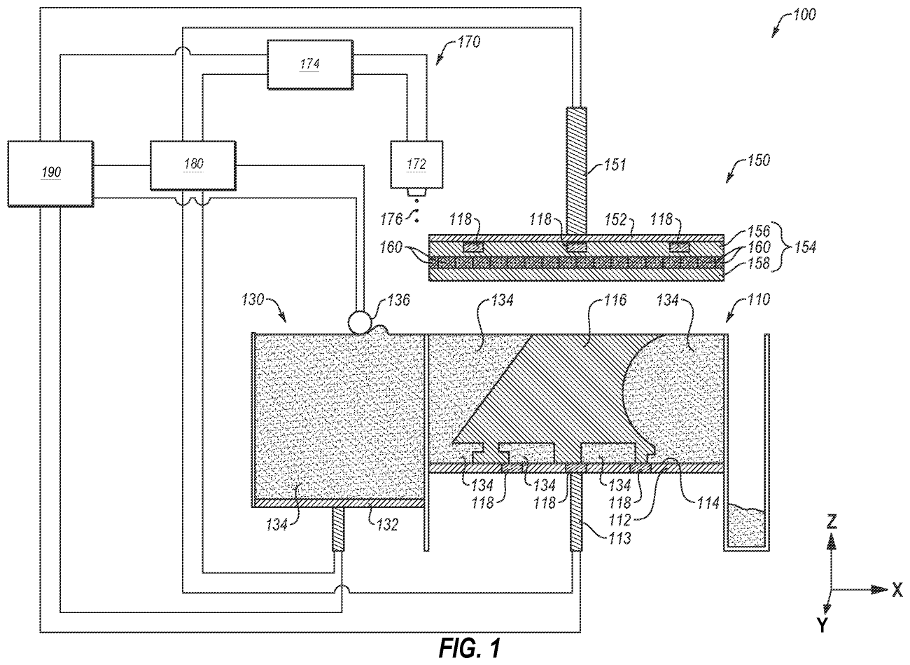

FIG. 1 illustrates an additive manufacturing system in accordance with embodiments of the disclosure. With the description provided below, it will be readily apparent to one of ordinary skill in the art that the additive manufacturing system described herein may be used in the fabrication of various structures. As non-limiting examples, the structures may be utilized in earth-boring or drilling operations and may include bit bodies or blades for rotary drill bits, downhole tool bodies and components, etc. As additional non-limiting examples, the structures may be utilized in industrial applications, such as impellers for rotary machinery, dies, molds, and/or fixtures for metal or non-metal forming processes, and the structures may further be utilized in biomedical applications such as prosthetic implants.

Referring to FIG. 1, an additive manufacturing system 100 may include a build assembly 110, a powder material assembly 130, and a compactor 150. The additive manufacturing system 100 may further include a binder system 170, a controller 180, and a heating system 190. The controller 180 may be operably coupled to the build assembly 110, the powder material assembly 130, the compactor 150, the binder system 170, and/or the heating system 190 and configured to control operation thereof. A non-limiting example of a suitable additive manufacturing system for modification according to the disclosure herein is the Triple Advanced Compaction Technology (ACT) system, offered by The ExOne Company of North Huntington, Pa., although implementation of embodiments of the disclosure is not limited to such a system, or equivalents.

The build assembly 110 may include a build platform 112 that includes a build surface 114 for supporting a component 116 under construction using the system 100. The build platform 112 may additionally include one or more force sensors 118 proximate the build surface 114 to measure a force applied to the build surface 114. The one or more foe sensors 118 may be laterally spaced (e.g., in the X-direction and Y-direction) throughout the build platform 112 and may be communicatively coupled with the controller 180. As a non-limiting example, the force sensors 118 may be uniformly or non-uniformly spaced from one another in the X-direction and/or the Y-direction.

The build platform 112 may include an actuator 113 (e.g., a linear hydraulic or pneumatic actuator under control of a linear encoder) for moving the build platform 112 incrementally in a vertical direction (e.g., in the Z-direction) during formation of a component 116. As a non-limiting example, the build platform 112 may be incrementally lowered in a vertical direction during an additive manufacturing process to form the component 116. The build platform 112 may comprise any conventional build platform known in the art.

The powder material assembly 130 may include a material delivery platform 132, a powder material 134, and a material applicator 136. The material delivery platform 132 may translate upward in the vertical direction (e.g., positive Z-direction) during a printing process to form the component 116. The material applicator 136 (e.g., roller, blade) may move the powder material 134 from the top of a supply of the powder material 134 resting on the material delivery platform 132, and then the material applicator 136 may translate horizontally to dispose the powder material 134 over the build platform 112. The powder material assembly 130 may comprise any conventional powder material assembly known in the art. Additionally, the powder material 134 may comprise any powder material known in the art that can be utilized in an additive manufacturing process suitable for the structure of the component being manufactured. Non-limiting material examples include, without limitation, metals, metal alloys and ceramics. The powder material 134 may also include more than one type of material. As a non-limiting example, the powder material 134 may comprise a mixture of metal particles and ceramic particles. The powder material 134 may also include particles of different sizes. As a non-limiting example, the powder material 134 may include relatively smaller particles and relatively larger particles. Additionally, the powder material 134 may be substantially homogeneous or may be heterogeneous in terms of material composition and/or particle size.

Continuing reference to FIG. 1, the binder system 170 may include a printing head 172 and a binder supply 174. The printing head 172 may deposit (e.g., jet) a binding agent 176 onto the powder material 134 according to the geometry of the component 116. The binding agent 176 may be selected specific to the powdered material 134 employed. Binding agents 176 suitable for use with metal, metal alloy and ceramic materials are offered by The ExOne Company referenced above. The binder system 170 may be or include any conventional binder deposition system known in the art. Subsequently, additional powder material 134 may be disposed over the binding agent 176 and the initial layer of powder material 134, and the process of spreading powder material and depositing binding agent 176 according to the geometry of the component 116 may be repeated to form superimposed, mutually bound layers of powder material 134 to ultimately form the component 116.

The controller 180 may include at least one processor, memory, an I/O interface, and a communication interface, which may be communicatively coupled by way of a communication infrastructure. The at least one processor includes hardware for executing instructions, such as the software configured as an operational program for the additive manufacturing system 100. The memory may be used for storing data, metadata, and programs for execution by the processor(s). The I/O interface allows a user to provide input to, receive output from, and otherwise transfer data to and receive data from the additive manufacturing system 100. The communication interface may include hardware, software, or both. In any event, the communication interface may provide one or more interfaces for communication (such as, for example, packet-based communication) between the additive manufacturing system 100 and one or more other computing devices or networks. In operation, the controller 180 may be programmed to slice input of a three-dimensional (3D) numerical model (e.g., computer aided design (CAD) model) of one or more components to be manufactured (e.g., the component 116) into layers via a conventional process to create a thin, substantially two-dimensional image simulating a thickness of each layer of powder material 134. The substantially two-dimensional image of each layer may be utilized by the additive manufacturing system 100 during one or more additive manufacturing processes to form any desired component (e.g., the component 116).

The heating system 190 may transfer heat to the powder material 134 and/or the binding agent 176 that may be disposed on the powder material 134 to activate (e.g., at least partially cure, crosslink) the binding agent 176 and at least partially bind particles of the powder material 134 to one another. The heating system 190 may be or include any conventional heating system known in the art. As non-limiting examples, the heating system 190 may include a resistive heating element, or may include a fluid passage for a heated fluid (e.g., air, liquid). The heating system 190 may be integrated into the compactor 150 and/or the build platform 112 or, alternatively, a laser system may be used to raster scan each layer and bind the powder material 134 in a desired configuration for the particular layer.

With continued reference to FIG. 1, the compactor 150 may include a compaction platform 152 and a compaction structure 154. The compaction structure 154 may include a backing material 156, an impedance layer 158, and one or more transducers 160 interposed between the backing material 156 and the impedance layer 158. The compaction structure 154 may vertically (e.g. in the Z-direction) underlie and be coupled to the compaction platform 152. The backing material 156 may include a first surface that may be in direct contact with and secured to a surface of the compaction platform 152. In some embodiments, the compaction structure 154 may be removably secured and/or electrically coupled to the compaction platform 152. In additional embodiments, the compaction structure 154 may be removable and replaceable with another compaction structure, which may be differently configured, and employ different materials.

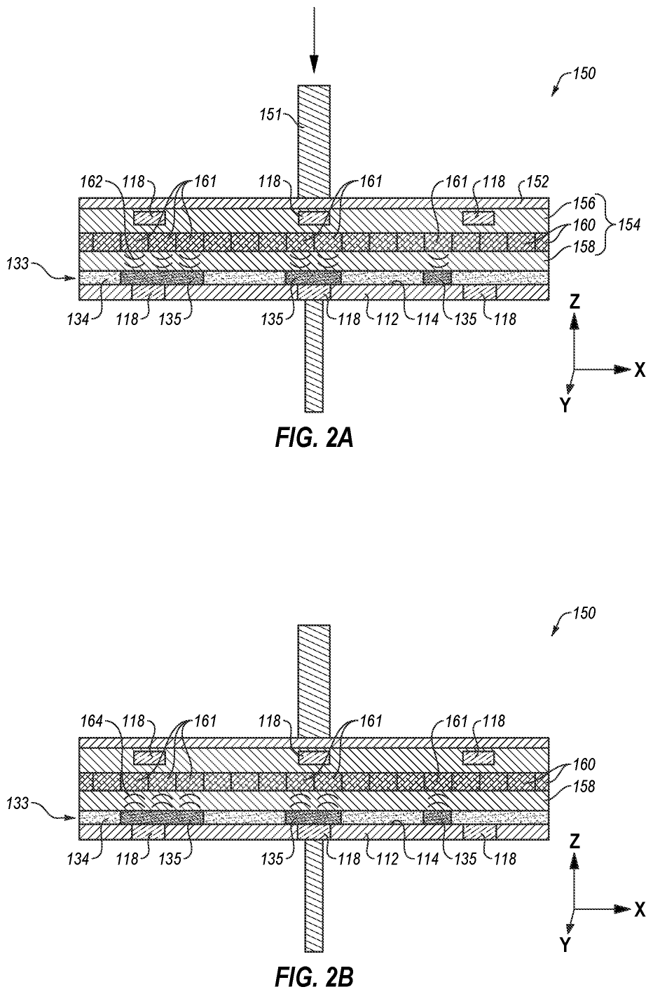

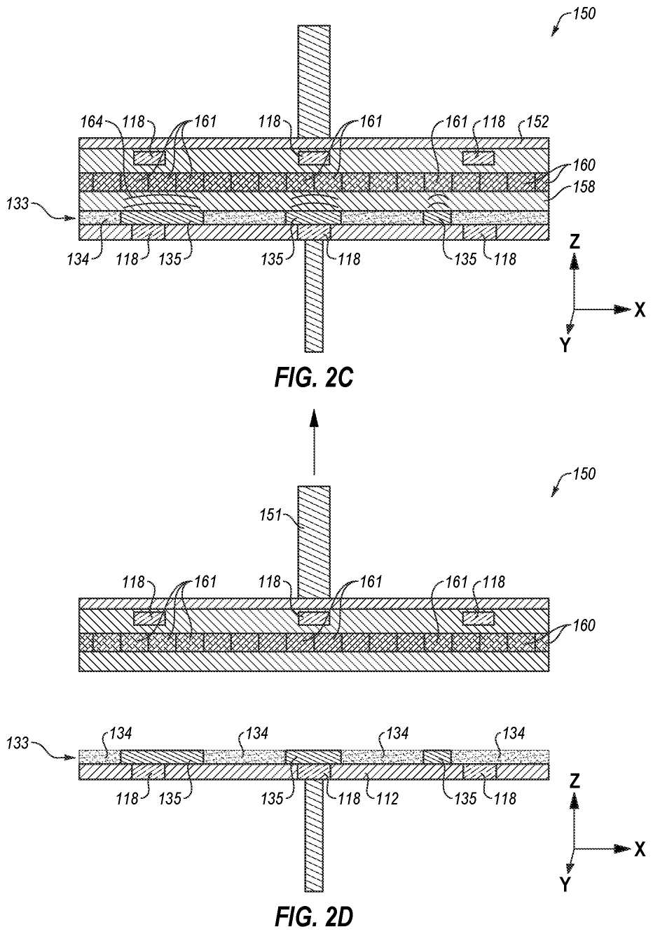

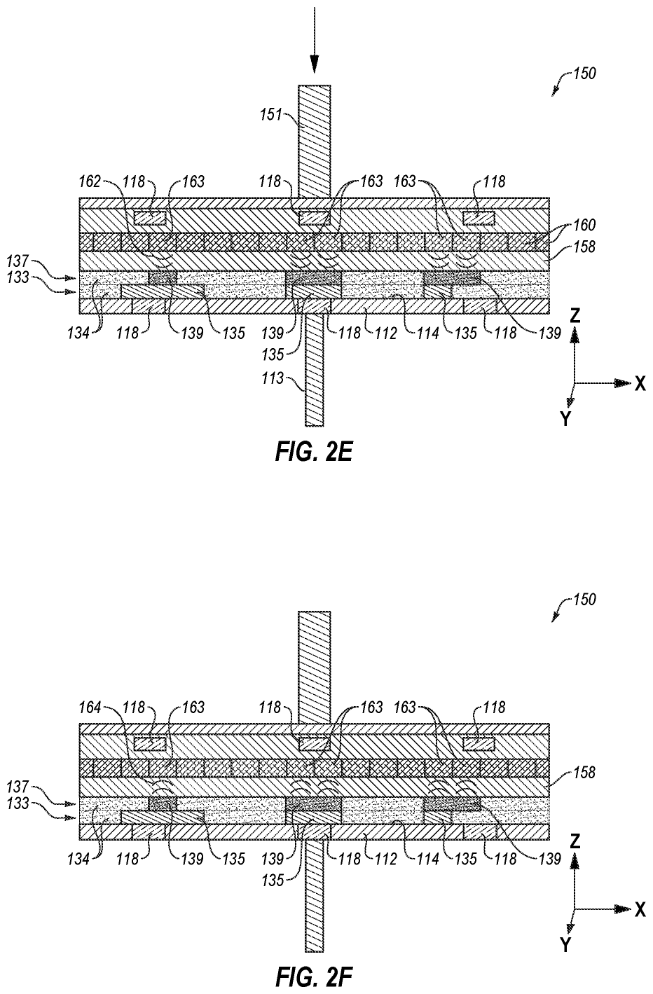

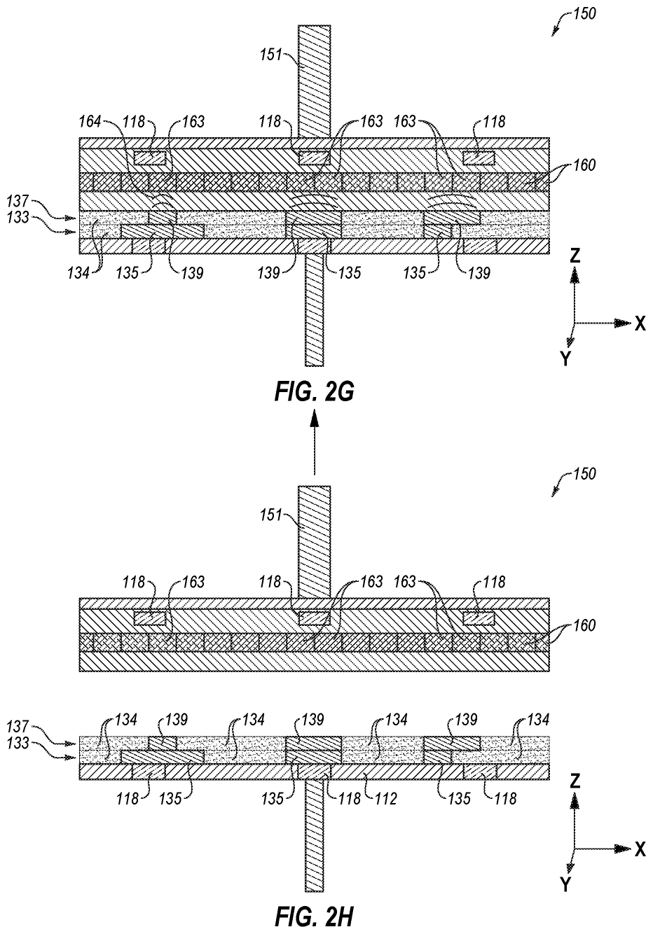

The compaction platform 152 may include an actuator 151 (e.g., a hydraulic or pneumatic actuator, optionally under control of a linear encoder for moving the compaction platform 152 in a vertical direction (e.g., Z-direction) and relative to the build platform 112. The compaction platform 152 may further include one or more additional actuators for moving the compactor in lateral (e.g., X-direction, Y-direction) directions. In operation, the compactor 150 may move the compaction platform 152 towards to the build platform 112 to position the compaction structure 154 in direct contact with the powder material 134 on the build surface 114. Additionally, the compactor 150 may move the compaction structure 154 away from (e.g., above or laterally adjacent to) the build surface 114 prior to conducting an additive manufacturing process, as described below with reference to FIGS. 2A-2H. In other words, the compactor 150 or at least the compaction platform 152 may be movable relative to the build surface 114 to make room for one or more other systems and/or components during an additive manufacturing process. As a non-limiting example, the compactor 150 may move the compaction platform 152 away from the build platform 112 to make room for dispensing of the powder material 134 or the printing head 172 for deposition of the binding agent 176 onto the powder material 134 on the build surface 114.

The compaction platform 152 may additionally include electrical connections for supplying electrical power to the compaction structure 154. As a non-limiting example, the compaction platform 152 may include a number of electrical connections to match a number of the one or more transducers 160, and each transducer 160 may be operably coupled to be individually actuated and deactuated by the controller 180.

The compaction platform 152 may include one or more force sensors 118 to measure a normal (i.e., vertical) force applied by compaction platform 152. The normal force may be attributable to the weight of the compaction platform 152, rather than a positive application of force, although in selected implementations a positive force may be applied. As a non-limiting example, the one or more force sensors 118 may be positioned within the compaction platform 152 proximate to the backing material 156. The force sensors 118 may be laterally spaced (e.g., in the X-direction and Y-direction) throughout the compaction platform and may be coupled to the controller 180. The force sensors 118 may be uniformly or non-uniformly spaced from one another in the X-direction and/or the Y-direction.

The backing material 156 may exhibit any desired shape and size, and may be substantially the same shape and size as the build platform 112. In other words, the backing material 156 may exhibit substantially the same lateral dimensions (e.g., X-dimensions, Y-dimensions) as the build platform 112. Additionally, the backing material 156 may have smaller X-dimensions and/or Y-dimensions than the build platform 112. The backing material 156 may include a surface 153 that may be substantially planar. The surface 153 of the backing material 156 may be positioned to face the build surface 114 and may be substantially parallel to the build surface 114. The backing material 156 may also exhibit any desired thickness. As a non-limiting example, the thickness of the backing material 156 may be selected to damp or eliminate excessive vibration of the one or more transducers 160 that may be attached thereto. The backing material 156 may include one or more metals, metal alloys, ceramics, polymers, and/or composite materials. As non-limiting examples, the backing material 156 may comprise a tungsten-based epoxy (e.g., an epoxy loaded with tungsten powder particles) and/or a bronze-based epoxy (e.g., an epoxy loaded with bronze powder particles).

In some embodiments, the backing material 156 may include the previously mentioned one or more force sensors 118 to measure a force applied to the backing material 156 by contact between compaction platform structure 154 and an uppermost, exposed layer of powder material 134 and/or binding agent 176 (if the additive manufacturing system uses a jetted binding agent). As a non-limiting example, the one or more force sensors 118 may be positioned within the backing material 156 proximate to the one or more transducers 160. The one or more force sensors 118 may be laterally spaced (e.g., in the X-direction and Y-direction) throughout the backing material 156 and may be coupled to the controller 180. As a non-limiting example, the force sensors 118 may be uniformly or non-uniformly spaced from one another in the X-direction and/or the Y-direction.

The one or more transducers 160 may be mounted on a surface 153 of the backing material 156, and the one or more transducers 160 may exhibit any suitable shape and size. As non-limiting examples, the one or more transducers 160 may exhibit a cylindrical shape, annular cylinder shape, rectangular prism shape, cube shape, hexagonal prism, or any combination thereof. Each of the one or more transducers 160 may include a first surface, a second surface opposite the first surface, and a third surface providing a lateral periphery to the transducer 160 and connecting the first surface to the second surface. The first surface may be on the surface 153 of the backing material 156 and the second surface may be on the impedance layer 158. The one or more transducers 160 may exhibit any desired size. By way of non-limiting example, lateral dimensions (e.g., in the X-direction, in the Y-direction, the diameter) of the one or more transducers 160 may be from about 1 millimeter (mm) to about 30 mm, such as from about 2 mm to about 25 mm, from about 5 mm to about 20 mm, or from about 8 mm to about 16 mm (e.g., about 12 mm). Additionally, the vertical dimensions (e.g., thickness) of the one or more transducers 160 may be from about 50 micrometers (μm) to about 30 mm, such as from about 1 mm to about 25 mm, from about 2 mm to about 20 mm, or from about 3 mm to about 15 mm (e.g., about 6 mm).

The one or more transducers 160 may be, for example, acoustic transducers, ultrasonic transducers, or piezoelectric transducers. In one implementation, one or more transducers 160 may include a piezoelectric crystal that is made from any suitable material exhibiting piezoelectricity. In other words, suitable materials for the piezoelectric crystal include those that accumulate an electric charge in response to applied mechanical stress and also generate internal mechanical strain in response to an applied electrical field. The piezoelectric crystal may comprise a variety of materials including one or more ceramics such as lead zirconate titanate (PbZrₓT₁₋ₓO3 with 0≤x≤1 (e.g., PZT-5A, PZT-5H, PZT 5-J, PZT-4, PZT-8)), potassium niobate (KNbO₃), sodium tungstate (Na₂WO₃), Ba₂NaNb₅O₅, Pb₂KNb₅O₁₅, zinc oxide (ZnO); lead-free piezoceramics such as sodium postassium niobate ((K,Na)NbO₃), bismuth ferrite (BiFeO₃), sodium niobate (NaNbO₃), barium titanate (BaTiO₃), bismuth titanate (Bi₄Ti₃O₁₂), sodium bismuth titanate (NaBi(TiO₃)₂); Group III-V and II-VI semiconductors such as galium nitride (GaN), indium nitride (InN), aluminum nitride (AlN), zinc oxide (ZnO); polymers such as polyvinylidene fluoride (PVDF) and its copolymers, polyamides, parylene-C, polyimide, and polyvinylidene chloride (PVDC); and various other crystalline materials such as langasite (La₃Ga₅SiO₁₄), gallium orthophosphate (GaPO₄), lithium niobate (LiNbO₃), lithium tantalate (LiTaO₃), quartz, berlinite (AlPO₄), rochelle salt, topaz, tourmaline-group minerals, and lead titanate (PbTiO₃). In some embodiments, the one or more transducers 160 comprise at least one of LiNbO₃, PZT-5A, PZT-5H, and PZT-8.

The one or more transducers 160 may be a number of transducers 160 and may be configured as an array of transducers 160, each transducer 160 of which may be positioned laterally (e.g., in the X-direction, Y-direction) in relation to one another. As a non-limiting example, each transducer 160 of the pattern or array of transducers 160 may be positioned laterally adjacent one another. As an additional non-limiting example, each transducer 160 may be positioned in lateral contact with one another to maximize a number of transducers 160 of the compaction platform 152 of compactor 150. The transducers 160 may be positioned on the backing material 156 in an ordered lateral arrangement (e.g., in rows and columns, in an array) or may be discretely positioned in a selected pattern suitable for the component being manufactured on the backing material 156. Rows and columns of transducers 160 may extend in the X-direction and/or the Y-direction across a portion of the surface 153 of the backing material 156 and may have more transducers in one direction (e.g., X-direction) than in another direction (e.g., Y-direction). As a non-limiting example, a row of transducers 160 may include a single transducer 160 in one direction (e.g., Y-direction) and multiple transducers 160 in another direction (e.g., X-direction). An array of transducers 160 may include any number of rows and columns of transducers 160, including a single row. As a non-limiting example, an array of transducers 160 may include transducers 160 laterally adjacent one another extending in both the X-direction and Y-direction across the entire surface 153 of the backing material 156.

The one or more transducers 160 may be operably coupled to a voltage source under direction of the controller 180 via the electrical connections of the compaction platform 152. Each transducer 160 of the one or more transducers 160 may be independently electrically selectively couplable to the voltage source under direction of the controller 180 so that each transducer 160 may be independently and selectively activated. In other words, each transducer 160 may have an individual parallel electrical connection for independently operating each transducer 160. In operation, the piezoelectric crystal of each of the one or more transducers 160 may, responsive to coupling with the voltage source, vibrate and generate an acoustic wave (e.g., an ultrasonic wave) in response to an applied voltage or may generate a feedback voltage in response to an applied vibration from a reflected acoustic wave (e.g., an ultrasonic wave). Vibrations and/or acoustic waves generated or emitted from activated transducers may, in a process which may be termed “sonication,” cause relative movement between particles of the powder material 134 and cause densification of the powder material 134 through, for example, local rearrangement of the particles of the powder material 134. From being exposed to the vibrations and/or acoustic waves of activated transducers in the sonication process, the local rearrangement of particles of the powder material 134 may provide an increased apparent density compared to powder particles that have not been exposed to the vibrations and/or acoustic waves and may expel possible air pockets that may be trapped within the powder material 134.

During sonication, a normal force is applied to the uppermost layer of powder material 134 by compactor 150 creating contact pressure that restricts motion of the particles of the powder material 134, forcing the particles to settle into a denser state. The normal force applied by the compactor 150 to restrict motion of the uppermost layer of powder material 134 may be minimal (e.g., less than or equal to the weight of the compaction platform 152). The contact pressure between the compactor 150 and the particles of the uppermost layer may also at least partially mechanically compact the uppermost layer of powder material 134. The force and resulting contact pressure applied by compactor 150 to the uppermost layer of powder material 134 may be within a range to effectively restrict motion of particles of the powder material 134 and to effectively densify layers of powder material 134 without resulting in powder-to-powder deformation that may distort and/or deform previously formed layers of the component 116. As a non-limiting examples, the range of contact pressure applied by compactor 150 to the uppermost layer of powder material 134 may be from about 0.001 megapascals (MPa) to about 60 MPa, from about 0.01 MPa to about 40 MPa, from about 0.1 MPa to about 20 MPa, from about 0.5 MPa to about 15 MPa, or from about 1 MPa to about 10 MPa. In some embodiments, the controller 180 may be programmed to independently activate each transducer 160 of the one or more transducers 160 to selectively densify at least a portion of a layer of powder material 134 corresponding to a cross-sectional area of a 3D model of a component (e.g., the component 116).

Continuing reference to FIG. 1, the impedance layer 158 may be on a surface of the one or more transducers 160 opposite the backing material 156. In some embodiments, the impedance layer 158 may be adhered to the one or more transducers 160. In additional embodiments, the impedance layer 158 may be secured to and tightly or densely packed with the one or more transducers 160. Tightly or densely packing the impedance layer 158 with the one or more transducers 160 may eliminate any air pockets which may degrade outgoing or incoming transducer signals.

The impedance layer 158 may, by coupling between the transducers 160 and an uppermost layer of powder material 134, allow acoustic waves emitted by the transducers 160 to efficiently enter a material (e.g., the powder material 134) used in an additive manufacturing process to form a component (e.g., the component 116). The impedance layer 158 may be engineered to substantially match an impedance of the powder material 134 and may substantially prevent the acoustic waves from reflecting off the powder material 134. Put another way, the impedance layer 158 may be designed and/or selected to reduce reflection of the acoustic (e.g., ultrasonic) waves emitted by the piezoelectric crystal from the powder material 134.

The impedance layer 158 may exhibit any desired dimensions (e.g., dimensions in the X-direction, Y-direction, and Z-direction) and may be made of any material suitable for matching the impedance of the powder material 134. As a non-limiting example, the impedance layer 158 may exhibit substantially the same lateral dimensions as the backing material 156 and/or the build platform 112 and may exhibit any suitable thickness (e.g., dimension in the Z-direction). In some embodiments, the impedance layer 158 may include the previously mentioned one or more force sensors 118 to measure a force applied to the impedance layer 158 by contact between compaction platform structure 154 and an uppermost, exposed layer of powder material 134 and/or binding agent 176 (if the additive manufacturing system uses a jetted binding agent). As a non-limiting example, the one or more force sensors 118 may be laterally spaced (e.g., in the X-direction and Y-direction) throughout the impedance layer 158 and may be coupled to the controller 180. As a non-limiting example, the force sensors 118 may be uniformly or non-uniformly spaced from one another in the X-direction and/or the Y-direction. Including the one or more force sensors 118 within the impedance layer 158 may improve sensitivity and/or accuracy of the detected forces because of the proximity of the one or more force sensors 118 to the applied force. Additionally, the one or more force sensors 118 within the impedance layer 158 may be able to better detect a small contact force applied to restrain powder particles during sonication.

The impedance layer 158 may be made of and include any suitable material and may, for example, be made of a material that facilitates the transmission of acoustic (e.g., ultrasonic) waves throughout the material. As non-limiting examples, the impedance layer 158 may be made of one or more metals, polymers, ceramics, glasses, composites, or any combination thereof. The impedance layer 158 may facilitate transferring waves generated by the one or more transducers 160 through the impedance layer 158 and into the powder material 134 to facilitate selective densification of the powder material 134. For example, the impedance layer 158 may be functionally graded (e.g., gradually varying in density, composition, and/or structure in at least one direction (e.g., across a thickness)) to maximize the number of acoustic waves transferred through the impedance layer 158 and into the powder material 134 to maximize vibration and movement between particles of the powder material 134. In other words, the acoustic impedance (Z_{M}) of the impedance layer 158 may be between the acoustic impedance (Z_{C}) of a piezoelectric ceramic crystal material and the acoustic impedance (Z_{P}) of the powder material 134 through which the acoustic waves from the transducers 160 may be propagated.

In some embodiments, the impedance layer 158 may include one or more quarter-wave impedance matching material layers. Generally, the energy transmission through a single quarter-wave impedance matching layer is maximized when the acoustic impedance of the single quarter-wave impedance matching layer is the geometric mean of the piezoelectric ceramic crystal (Z_{C}) and the medium (Z_{P}), as represented in the following:

Z_{M}=\sqrt{Z_{C}Z_{P}}

Additionally, designs of single and multiple impedance matching layers may optimize pulse-echo performance parameters of the one or more transducers 160. Optimizing pulse-echo performance parameters of the one or more transducers 160 for a single impedance matching layer may be represented by the following:

Z_{M}=\sqrt{Z_{C}^{1/3}Z_{P}^{2/3}}

Optimizing pulse-echo performance parameters of the one or more transducers 160 for a double impedance matching layer may be represented by the following:

$${Z}_{M 1} = \sqrt{{Z}_{C}^{4 / 7} {Z}_{P}^{3 / 7}}$$

$${Z}_{M 2} = \sqrt{{Z}_{C}^{1 / 7} {Z}_{P}^{6 / 7}}$$

Because the impedance layer 158 may be customized in view of the impedance of the powder material 134, one or more additional compaction structures (e.g., similar to the compaction structure 154) may be formed to include different impedance matching layers. The one or more additional compaction structures may each include a backing material substantially identical to the backing material 156, and one or more transducers that are substantially identical to the one or more transducers 160, while an impedance matching layer or layers may be different from the impedance layer 158 in terms of material, composition, thickness, and impedance. The one or more additional compaction structures may be interchangeable with the compaction structure 154 and may be secured to the compaction platform 152 to form a compactor with a different impedance. The compaction structure 154 and the one or more additional compaction structures may be utilized for a specific types of the powder material 134.

Although illustrated as a component within a binder-jet additive manufacturing system, the compactor 150 may be utilized in any additive manufacturing system and/or any additive manufacturing process. As non-limiting examples, the compactor 150 may be utilized in one or more additive manufacturing processes, such as, for example, binder jetting, inkjet 3D printing, directed metal deposition, micro-plasma powder deposition, direct laser sintering, selective laser sintering, selective laser melting, electron beam melting, electron beam freeform fabrication, laminated object manufacturing, or stereolithography as well as other additive manufacturing processes.

Furthermore, although the compactor 150 is illustrated as a standalone component of the additive manufacturing system 100, the compaction platform 152 of the compactor 150 may be omitted and the compaction structure 154 including the backing material 156, the impedance layer 158, and the one or more transducers 160 therein may be integrated into or combined with other components of additive manufacturing systems such as, for example, the material applicator 136.

The compactor 150 may be employed in an additive manufacturing process to facilitate the formation of a component (e.g., the component 116) exhibiting enhanced properties compared to components formed through conventional additive manufacturing processes. For example, a frequency, wavelength, bandwidth, cycle time, waveform, and attenuation of the transducers 160 of the compaction platform 152 of compactor 150 in combination with characteristics of impedance layer 158 may be engineered to optimize the densification of the powder material 134. As a non-limiting example, the one or more transducers 160 and the impedance layer 158 may be designed to induce localized waves and/or vibrations into the powder material 134 at about the resonant frequency (e.g., natural frequency) of the powder material 134 to maximize mutually collapsing movement of individual powder particles (i.e., movement toward one another) and, therefore, maximize the apparent density of the powder material. The increased apparent density may, for example, increase the apparent density of additively manufactured components compared to the about 40% to about 60% apparent density achievable by conventional additive manufacturing methods. As non-limiting examples, the apparent density of additively manufactured components in accordance with this disclosure may be within a range from about 60% to about 99%, such as from greater than about 60% to about 99%, from about 62% to about 99%, from about 65% to about 99%, from about 68% to about 98%, from about 70% to about 98%, or from about 75% to about 97%. The increased apparent density of additively manufactured components may also lead to enhanced material properties compared to conventional additively manufactured components, such as one or more of toughness, shear strength, compressive strength, tensile strength, impact resistance and electrical conductivity of a given component (e.g., the component 116). Furthermore, selectively densifying powder materials during an additive manufacturing process may enable engineering the microstructure of a component to possess desired material properties. Additionally, the selective or localized densification of powder materials during an additive manufacturing process may improve the efficiency of additively manufacturing components because the densification of powder material may be localized to areas that ultimately form one or more components (e.g., the component 116).

For clarity and by way of example and not limitation, a description of an example additive manufacturing method by which one or more components (e.g., the component 116) may be formed is provided below with reference to FIGS. 2A-2H. In operation, the controller 180 (FIG. 1) may slice a three-dimensional model (e.g., 3D CAD model) into layers via a conventional process to create a substantially two-dimensional image of each layer including a thickness of each layer. Subsequently, the material applicator 136 (FIG. 1) may spread a first thin layer 133 of the powder material 134 (e.g., about 0.1 mm thick layer of material) over the build surface 114 and the build platform 112.

Referring now to FIG. 2A, the compaction platform 152 of compactor 150 may move vertically lower (e.g., in the negative Z-direction) via the actuator 151 so the impedance layer 158 is in contact with the first layer (e.g., the layer) 133 of the powder material 134. As a non-limiting example, the impedance layer 158 may be vertically aligned with and parallel to the first layer 133 of the powder material 134 so there is direct and proper contact between entire surfaces of the impedance layer 158 and the first layer 133 of the powder material 134. The compaction platform 152 of compactor 150 may apply a vertical force directly onto the first layer 133 via the impedance layer 158 resulting in contact pressure that secures the powder material 134 in place during a densification process. As non-limiting examples, the applied vertical force to secure the powder material 134 in place may correspond to a contact pressure of at least about 0.001 MPa, at least about 0.01 MPa, at least about 0.1 MPa, at least about 0.5 MPa, or at least about 1 MPa. Additionally, the compaction platform 152 of compactor 150 may apply a vertical force corresponding to a contact pressure that at least partially mechanically densifies the at least a portion 135 of the first layer 133 without resulting in particle-to-particle deformation. As a non-limiting examples, the applied vertical force to at least partially mechanically densify the powder material 134 of the at least a portion 135 may correspond to a contact pressure less than or equal to about 60 MPa, less than or equal to about 40 MPa, less than or equal to about 20 MPa, less than or equal to about 15 MPa, or less than or equal to about 10 MPa. The force applied by the compactor 150 onto the first layer 133 may be measured by the one or more force sensors 118 within the compactor 150 and/or the build platform 112. The controller 180 (FIG. 1) may store an initial threshold (e.g., set point) force value corresponding to a contact pressure at which the at least a portion 135 of the first layer 133 reaches a certain apparent density without resulting in particle-to-particle deformation. As non-limiting examples, the initial threshold force value may correspond to a contact pressure from about 1 MPa to about 60 MPa, from about 5 MPa to about 40 MPa, from about 10 MPa to about 30 MPa (e.g., about 20 MPa). If the force sensors 118 detect a force that is the same or greater than the initial threshold force value, the compactor 150 may stop applying force to the first layer 133 and the compaction platform 152 may vertically move (e.g., in the Z-direction) away from the build platform 112. The initial threshold force value may depend on factors such as, for example, the type of powder material 134, if binding agent 176 (FIG. 1) was deposited on the powder material 134, or if any heat applied to the powder material 134 and/or the binding agent 176 (FIG. 1).

A voltage may be applied to activate at least one transducer 161 of the one or more transducers 160 to induce localized vibrations and generate or emit localized acoustic (e.g., ultrasonic) waves 162 at areas corresponding to a cross-sectional configuration and area of the component 116 (FIG. 1). Other transducers 160 of the one or more transducers 160 may remain inactive. As non-limiting examples, the at least one active transducer 161 may include a single transducer 160, may include some or fewer than all of the one or more transducers 160, or may include all of the one or more transducers 160. The acoustic waves 162 may propagate through the impedance layer 158 and into the powder material 134 at specific locations of the first layer 133 corresponding to the at least one active transducer 161. As shown in FIG. 2A, the vibrations and/or the acoustic waves 162 generated or emitted from the at least one activate transducer 161 may propagate through one or more localized areas of the impedance layer 158 and into one or more localized areas of the first layer 133. The vibrations and/or acoustic waves 162 may cause relative movement between particles of the powder material 134 of the at least a portion 135 of the first layer 133 corresponding to a cross-sectional area of the component 116 (FIG. 1). The relative movement between particles of the powder material 134 may densify the powder material 134 of the at least a portion 135 of the first layer 133 through, for example, local rearrangement of the particles of the powder material 134. From being exposed to the vibrations and/or acoustic waves 162 of activated transducers in combination with applied normal force from compaction platform 152 substantially precluding unconstrained movement of particles of powder material 134 in response to sonication, the local rearrangement of particles of the powder material 134 of the at least a portion 135 of the first layer 133 may provide an increased apparent density compared to powder particles that have not been exposed to the vibrations and/or acoustic waves and may expel possible air pockets that may be trapped within the powder material 134. In other words, the at least one transducer 161 may selectively densify at least a portion 135 of the first layer 133 of the powder material 134. In some embodiments, the at least one transducer 161 may emit ultrasonic waves at about a resonant frequency of the powder material 134 to densify at least the portion 135 of the first layer 133.

Referring now to FIG. 2B, at least some of the acoustic waves 162 (FIG. 2A) may reflect off of the build surface 114 and/or a surface of the first layer 133 of the powder material 134 in contact with the impedance layer 158 and propagate back into the at least one active transducer 161 and/or the one or more inactive transducers 160. The at least one active transducer 161 and/or the one or more inactive transducers 160 may receive the reflected acoustic waves 164 and may continue to emit localized acoustic waves 162 depending on the signature of the reflected acoustic waves 164. For example, the reflected acoustic waves 164 may have a signature indicating that the at least a portion 135 of the first layer 133 has not yet reached a certain apparent density. Additionally, the one or more force sensors 118 may continue to monitor the vertical force being applied to the first layer 133. As a non-limiting example, the controller 180 (FIG. 1) may compare the force applied to the initial threshold force value.

Referring now to FIG. 2C, the signature of the reflected acoustic waves 164 may change once the at least a portion 135 of the first layer 133 has reached a certain apparent density. As non-limiting examples, the signature of the reflected acoustic waves 164 may change once the at least a portion 135 of the first layer 133 of powder material 134 has an apparent density of at least about 60%, such as greater than about 60%, at least about 62%, at least about 65%, at least about 70%, at least about 80%, or at least about 95% and exceeds a tap density achievable under the conditions specified in ASTM B527-20. The at least one transducer 161 and/or the one or more other transducers 160 may receive the reflected acoustic waves 164 with the modified signature and may stop vibrating and stop generating the localized acoustic waves 162. The controller 180 may employ the signatures of reflected acoustic waves 164 (e.g., backscattering or selectively identified reflections) from the various transducers 160 to activate and deactivate individual transducers 160 until a substantially uniform apparent density of the first layer 133 is achieved. Additionally, the one or more force sensors 118 may detect a force that corresponds to the initial threshold force and may signal that the at least a portion 135 of the first layer 134 has achieved a certain apparent density.

Referring now to FIG. 2D, once the one or more force sensors 118 have detected an applied force corresponding to the initial threshold force and the reflected acoustic waves 164 received by the various transducers 160 indicate that a substantially uniform apparent density of the at least a first portion 135 has been achieved, the at least one active transducer 161 may be deactivated and the compaction platform 152 may be moved (e.g. vertically) away from the build platform 112 via the actuator 151. The first layer 133 may include a combination of the powder material 134 in a loose state and the at least a portion 135 of consolidated powder material in a dense state of a target apparent density corresponding to a cross-section of a component (e.g., the component 116 (FIG. 1)). The binder system 170 (FIG. 1) may then deposit a binding agent 176 on the at least a portion 135 of the powder material 134 that diffuses into the interstices between the powder particles by capillary force to bond the particles together. In some embodiments, the binding agent 176 (FIG. 1) and the at least a portion 135 of the first layer 133 may be heated to at least partially cure (e.g., crosslink) the binding agent 176 (FIG. 1) to bind the powder material 134 located within the at least a portion of the layer.

During densification, the at least a portion 135 of the first layer 133 sinks and creates a recess relative to the remaining powder material 134 of the first layer 133 that may be filled with additional powder material 134 when forming subsequent layers. The depth (e.g., in the Z-direction) of the recess can be determined by calculating the ratio of the apparent density of the at least a portion 135 before densification (e.g., 40%) and the apparent density of the at least a portion 135 following densification (e.g., 60% or more) multiplied by the thickness (e.g., in the Z-direction) of the first layer 133. In other words, the depth of the recess within the at least a portion 135 of the first layer can be determined by the following equation:

$$Recess Depth = 1 - \frac{Apparent {density}_{before}}{Apparent {density}_{after}} * Original layer thickness$$

Referring now to FIG. 2E, the build platform 112 may vertically lower by the thickness of the first layer 133 of powder material 134 via the actuator 113 and then the material applicator 136 (FIG. 1) may spread a second thin layer 137 of the powder material 134 (e.g., about 0.1 mm thick layer of additional powder material) over the build surface 114, the build platform 112, and the second layer (e.g., the another layer) 137 of powder material 134. Because of the recess within the at least a portion 135 of the first layer, the material applicator 136 may spread additional powder material 134 and/or make more than one pass over first layer 133 so an upper surface of the second layer 137 has a substantially uniform height (e.g., distance from the build surface 114 in the Z-direction). The material applicator 136 may spread a second layer of the powder material 134 on an exposed surface of the first layer 133 of the densified and bound powder material 134.

The compaction platform 152 may move vertically lower (e.g., in the negative Z-direction) via the actuator 151 so the impedance layer 158 is in contact with the second layer 137 of the powder material 134. The compaction platform 152 may apply a vertical force directly onto the second layer 137 via the impedance layer 158 resulting in contact pressure that secures the second layer 137 of the powder material 134 in place during a densification process. As non-limiting examples, the applied vertical force to secure the powder material 134 in place may correspond to a contact pressure of at least about 0.001 MPa, at least about 0.01 MPa, at least about 0.1 MPa, at least about 0.5 MPa, or at least about 1 MPa. Additionally, the compaction platform 152 may apply a vertical force corresponding to a contact pressure that at least partially mechanically densifies at least another portion 139 of the second layer 137 corresponding to another cross-sectional area of the component 116 (FIG. 1) without resulting in particle-to-particle deformation that may distort and/or deform the densified at least a portion 135 of the first layer 133. As a non-limiting examples, the applied vertical force to at least partially mechanically densify the powder material 134 of the at least a portion 135 may correspond to a contact pressure less than or equal to about 60 MPa, less than or equal to about 40 MPa, less than or equal to about 20 MPa, less than or equal to about 15 MPa, or less than or equal to about 10 MPa. Additionally, the impedance layer 158 may be vertically aligned with and parallel to the second layer 137 of the powder material 134 so there is direct and proper contact between entire surfaces of the impedance layer 158 and the second layer 137 of the powder material 134. The force applied by the compaction platform 152 onto the second layer 137 may be measured by the one or more force sensors 118 within the compactor 150 and/or the build platform 112. The controller 180 (FIG. 1) may store a new initial threshold (e.g., set point) force value corresponding to a contact pressure at which the at least another portion 139 of the second layer 137 has reached a certain apparent density, without resulting in distortion and/or deformation of the at least a portion 135 of the first layer 133. As non-limiting examples, the initial threshold force value may correspond to a contact pressure from about 1 MPa to about 60 MPa, from about 5 MPa to about 40 MPa, from about 10 MPa to about 30 MPa (e.g., about 20 MPa). If the force sensors 118 detect a force that is the same or greater than the new initial threshold force value, the compactor 150 may stop applying force to the first layer 133 and the compaction platform 152 may vertically move (e.g., in the Z-direction) away from the build platform 112. In some embodiments, the new threshold force value that may be different (e.g., less) than the initial threshold force value. The new threshold force may depend on factors such as, for example, the type of the powder material 134, if any heat is applied to the powder material 134 and/or the binding agent 176 (FIG. 1), the number of layers of and densified powder material 134, and the presence and/or quantity of binding agent 176 on other layers. Signal magnitude from the force sensors 118 as each new layer of powder material 134 is being densified may be used to prevent overpressure damage to, or collapse, of already mutually bound and densified layers of powder material 134 of a partially formed component 116.

Continuing with FIG. 2E, a voltage may be applied to activate at least another transducer 163 of the one or more transducers 160 to induce localized vibrations and generate or emit localized acoustic (e.g., ultrasonic) waves 162 at areas corresponding to another cross-sectional configuration and area of the component 116 (FIG. 1). The acoustic waves 162 may propagate through the impedance layer 158 and into the powder material 134 at specific locations of the second layer 137 corresponding to the at least another active transducer 163. As shown in FIG. 2E, the vibrations and/or the acoustic waves 162 generated or emitted from the at least another activated transducer 163 may propagate through one or more localized areas of the impedance layer 158 and into one or more localized areas of the second layer 137. The vibrations and/or acoustic waves 162 may cause relative movement between particles of the powder material 134 of the at least another portion 139 of the second layer 137 corresponding to another cross-sectional area of the component 116 (FIG. 1) and densify the powder material 134 of the at least another portion 139 of the second layer 137 in substantially the same manner as the at least one portion 135 of the first layer 133. In other words, the at least another activated transducer 163 may selectively densify the at least a portion 139 of the second layer 137 of the powder material 134. As illustrated in FIG. 2E, activating the at least another transducer 163 to densify the at least another portion 139 of the second layer 137 may include activating different transducers than those of the at least one transducer 161 that were activated to densify the at least a portion 135 of the first layer 133.

Referring now to FIG. 2F, at least some of the acoustic waves 162 (FIG. 2E) may reflect off one or more of the build surface 114, the at least a portion 135 of the first layer 133, or a surface of the second layer 137 in contact with the impedance layer 158 and propagate back into the at least another active transducer 163 and/or the one or more inactive transducers 160. The at least another transducer 163 and/or the one or more inactive transducers 160 may receive the reflected acoustic waves 164 and may continue to emit localized acoustic waves 162. For example, the reflected acoustic waves 164 may have a signature indicating that the at least another portion 139 of the second layer 137 has not yet reached a certain apparent density. Additionally, the one or more force sensors 118 may continue to monitor the vertical force being applied to the second layer 137. As a non-limiting example, the controller 180 (FIG. 1) may compare the applied force to the new threshold force value.

Referring now to FIG. 2G, the signature of the reflected acoustic waves 164 may change once the at least another portion 139 of the second layer 137 has reached a certain apparent density. As non-limiting examples, the signature of the reflected acoustic waves 164 may change once the powder material 134 has an apparent density of at least about 60%, such as greater than about 60%, at least about 62%, at least about 65%, at least about 70%, at least about 80%, or at least about 95%. Additionally, the at least another portion 139 of the second layer 137 may have the same or substantially the same apparent density as the at least a portion 135 of the first layer 133. The at least another transducer 163 and/or the one or more transducers 160 may receive the reflected acoustic waves 164 with the modified signature and may stop vibrating and stop generating the localized acoustic waves 162. The controller 180 may employ the signatures of reflected acoustic waves 164 from the various transducers 160 to activate and deactivate individual transducers 160 until the apparent density of the at least another portion 139 is at least substantially the same as the apparent density of the at least one portion 137. Additionally, the one or more force sensors 118 may detect a force that corresponds to the threshold force.

Referring now to FIG. 2H, once the force sensors have detected an applied force corresponding to the threshold force and the reflected acoustic waves 164 received by the various transducers 160 indicate that the apparent density of the at least another portion 139 and the at least one portion 137 is at least substantially the same, the at least another transducer 163 may be deactivated and/or the compaction platform 152 may move (e.g. vertically) away from the build platform 112 via the actuator 151. The second layer 137 may include a combination of the powder material 134 in a loose state and the at least another portion 139 of consolidated powder material in a mutually bound and dense state corresponding to another cross-section of the component 116 (FIG. 1). Force applied by the compaction platform 152 to the second layer 137 during the densification of the second layer 137 may at least partially combine the at least a portion 135 of the first layer 133 and the at least another portion 139 of the second layer 137 to form a larger portion of a component being additively manufactured (e.g., the component 116 (FIG. 1)). The binder system 170 (FIG. 1) may deposit additional binding agent 176 onto at least another portion 139 of the second layer 137 of the powder material 134 corresponding to another cross-section of the component 116 (FIG. 1) to be selectively densified via the compactor 150.

During densification, the at least another portion 139 of the second layer 137 sinks and creates another recess relative to the remaining powder material 134 of the second layer 137 in substantially the same manner as previously discussed. Additional powder material 134 may be added to fill the another recess and form an additional layer with a substantially uniform height (e.g., distance from the build surface 114 in the Z-direction).

The process of 2E-2H may be repeated any number of times to form a completed component (e.g., the component 116 (FIG. 1)).

Once a component (e.g., the component 116 (FIG. 1) has been formed, the component may undergo post-processing. For example, the component 116 (FIG. 1 may be infiltrated with a liquid metal or alloy infiltrant, or may be heated and thermally treated, as by annealing or sintering. As other non-limiting examples, post-processing may also include removing excess surface material, removing internal support structures, repairing portions of the component, cleaning, curing, sanding, polishing, and coloring (e.g., painting).

Embodiments of methods of additive manufacturing and additive manufacturing systems in accordance with the disclosure may increase the apparent density achievable through additive manufacturing compared to conventional additive manufacturing methods, while also manufacturing the densified components to a specified size and shape (e.g., without resulting in shrinkage and distortion or deformation). The increased apparent density of additively manufactured components (e.g., of densified components) may lead to enhanced material properties such as one or more of toughness, shear strength, compressive strength, tensile strength, impact resistance and electrical conductivity of a given component. Additionally, the ability to selectively densify powder materials during an additive manufacturing process may enable engineering of the microstructure of components in order to possess desired material properties. Furthermore, the selective or localized densification of powder materials during an additive manufacturing process may improve the efficiency of additively manufacturing components because the densification of powder material may be localized to areas that ultimately form one or more densified components.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed is:

1. A method of additive manufacturing, the method comprising:
disposing a layer of powder material on a surface of a build platform of an additive manufacturing apparatus;
placing a compaction platform comprising one or more transducers in contact with an upper surface of the layer of a powder material; and
activating at least one transducer of the one or more transducers of a compaction platform of a compactor to densify a portion of the layer of the powder material below the at least one transducer.

2. The method of claim 1, wherein activating the at least one transducer of the one or more transducers comprises activating at least one ultrasonic transducer.

3. The method of claim 2, wherein activating the at least one ultrasonic transducer comprises emitting ultrasonic waves at a resonant frequency of the powder material.

4. The method of claim 3, further comprising receiving ultrasonic waves reflected from one or more of the build platform, the powder material of the layer and an upper surface of the layer of the power material with the at least one ultrasonic transducer.

5. The method of claim 1, further comprising depositing a binding agent onto at least a densified portion of the layer of the powder material after activating the at least one transducer of the one or more transducers to densify a portion of the layer of the powder material below the at least one transducer.

6. The method of claim 5, further comprising heating the binding agent and the at least a portion of the layer to at least partially cure the binding agent to the powder material of the at least a densified portion of the layer.

7. The method of claim 1, wherein contacting a surface of the layer of the powder material with the compaction platform comprises contacting the surface with an impedance layer of the compactor.

8. The method of claim 1, further comprising:
applying a normal force to the at least a portion of the layer of the powder material with the compaction platform while the at least one transducer is activated;
detecting a magnitude of the applied normal force with one or more force sensors of the compaction platform; and
moving the compaction platform out of contact with the layer of the powder material responsive to the detected normal force reaching a selected threshold value.

9. The method of claim 1, further comprising, after removing the compaction platform from contact with the layer of the powder material:
disposing another layer of the powder material on an exposed surface of the layer
placing the compaction platform in contact with the another layer of powder material; and
activating at least one transducer of the one or more transducers of the compaction platform to selectively densify a portion of the another layer of the powder material.

10. The method of claim 1, wherein activating the at least one transducer comprises activating transducers of the one or more transducers to selectively densify the portion of the layer of the powder material corresponding to a cross-sectional area and configuration of a component.

11. The method of claim 1, wherein activating the at least one transducer comprises individually activating a number of transducers to densify the powder material of the layer to substantially a uniform apparent density.

12. A system for additively manufacturing components, the system comprising:
a build platform configured to support layers of powder material forming a component;
a material applicator configured to dispose layers of the powder material over the build platform; and
a compactor comprising a compaction platform movable to positions over the build platform and into contact with individual layers of the powder material after disposition thereof over the build platform, the compaction platform comprising a number of downwardly aimed ultrasonic transducers configured to densify portions of the powder material.

13. The system of claim 12, wherein the compaction platform comprises:
a backing material;
at least one impedance layer; and
the number of downwardly aimed ultrasonic transducers interposed between the backing material and the impedance layer.

14. The system of claim 13, wherein the impedance layer is configured to facilitate transmission of ultrasonic waves from the ultrasonic transducers into the powder material.

15. The system of claim 13, wherein the number of ultrasonic transducers comprises an array of piezoelectric transducers extending laterally under the backing material.

16. The system of claim 12, further comprising one or more force sensors operably coupled to at least one of the build platform or the compaction platform and positioned to measure a normal force applied by the compactor to an uppermost layer of the powder material.

17. The system of claim 12, further comprising an actuator for moving the compaction platform into and out of contact with an uppermost layer of the powder material.

18. The system of claim 12, further comprising a heating device integrated into at least one of the compaction platform or the build platform, the heating device being operable to at least partially mutually bind particles of the powder material.

19. The system of claim 13, further comprising:
a controller operably coupled to each of the number of ultrasonic transducers of the compaction platform and configured to individually activate ultrasonic transducers of the number of ultrasonic transducers to densify a portion of the powder material of an uppermost layer under and in contact with the compaction platform.

20. The system of claim 19, wherein the ultrasonic transducers are configured to receive reflected ultrasonic waves of the uppermost layer indicative of an apparent density of the powder material and the controller is configured to individually activate and deactivate individual transducers responsive to an indicated apparent density of the powder material of the uppermost layer.
